(19) United States
(12) Patent Application Publication
(10) Pub. No.: US 2012/0320592 A1
(43) Pub. Date: Dec. 20, 2012

(54) MULTIUNIT AND MULTIFACETED LIGHTING LED LAMP

(76) Inventor: Zhijian Zhou, Zhongshan (CN)

(21) Appl. No.: 13/478,700

(22) Filed: May 23, 2012

(30) Foreign Application Priority Data
Jun. 15, 2011 (CN) 201120201405.3

(51) Int. Cl. F21V 21/00; F21V 9/16

(52) U.S. Cl. 362/249.02

(57) ABSTRACT

A multiunit and multifaceted LED lamp includes a lamp body with an end surface and side surface, on which LED bead groups are arranged respectively; on the lamp body a connecting apparatus which is able to connect to the power source is arranged, and through the different connection modes of the connecting apparatus, different LED bead groups are turned on or off under control, so as to obtain various luminous effects and light emitting ranges. A 180 degree light emitting angle is obtained while the LED bead group on the end surface lights up, and a 360 degree light emitting angle is obtained while the LED bead groups on the side surface light up. The LED lamp may be used in car as a headlight, a high beam light, an indicator light, and a low beam light.

### CROSS-REFERENCE TO RELATED APPLICATIONS

This application claims the benefit of Chinese Application No. 201120201405.3, filed Jun. 15, 2011, the content of which is incorporated by reference herein.

### TECHNICAL FIELD

The present invention relates to a lamp, and more particularly to a multiunit and multifaceted LED (light-emitting diode) lamp.

### BACKGROUND INFORMATION

As having the advantages such as low energy consumption, pollution free, high efficiency and so on, LED products are widely used in home, office, shopping mall and even car as illumination luminaries. However, the existing LEDs have the following disadvantages as illumination source: LEDs as a kind of flat-packaged point light sources, have to employ lens or like measures to enhance their emitting angles, however, even using lens the maximum emitting angle is about 160 degree only, furthermore, LEDs generate a great deal of heat while working, all of those result in great luminous decay, impaired service lifetime, and the lack of the ability of lighting from a plurality of planes or at various angles.

### SUMMARY OF THE INVENTION

In order to overcome the drawbacks of the existing technologies, the present invention seeks to provide an LED lamp with great heat dissipation, more importantly the LED lamp should be able to allows a plurality of LED groups mounted on its plurality of planes to emit light respectively or simultaneously, for various light-emitting angles.

The technical solution adopted by the present invention to solve its technical problem is as follow:

A multiunit and multifaceted lighting LED lamp, comprising a lamp body with an end surface and a side surface; LED bead groups, arranged on the end and side surfaces; a connecting apparatus arranged on the lamp body, and connecting the LED bead groups to a power source; wherein the LED bead groups can be respectively switched on or off under the control of the connecting apparatus through the different connection modes of the connecting apparatus.

The connecting apparatus comprises a negative connecting terminal connected to the LED bead groups, and a positive connecting terminal connected to the corresponding LED bead groups.

One LED bead group is arranged on the end surface and two LED bead groups are arranged on the side surface.

The positive connecting terminal comprises a first connecting terminal, a second connecting terminal and a third connecting terminal, which are connected to the corresponding LED bead groups respectively.

The negative connecting terminal may be a threaded cylindrical shell, and the first connecting terminal, second connecting terminal and third connecting terminal may be three lengths of cylindrical shells with different semi-diameters, wherein one end of the first connecting terminal is inserted into the negative connecting terminal; one end of the second connecting terminal is inserted into the first connecting terminal; one end of the third connecting terminal is inserted into the second connecting terminal; and the negative connecting terminal, the first connecting terminal, the second connecting terminal and the third connecting terminal are separated with each other by insulators.

The LED lamp further comprises phosphor applied on the end surface and side surface.

The advantageous effects of the present invention could be: in the present invention the lamp body is provided with an end surface and a side surface, on which LED bead groups are arranged respectively, as well as on the lamp body a connecting apparatus which is able to connect the power source, and consists of a first connecting terminal, a second connecting terminal and a third connecting terminal, is mounted. Through the different connections to the first, second and third connecting terminals, different luminous effects and light emitting ranges are obtained.

A 180 degree light-emitting angle is obtained while the LED bead group on the end surface lights up, and a 360 degree light-emitting angle is obtained while the LED bead groups on the side surface light up, furthermore, as the LED bead groups all emit direct light and have lower heat, the service lifetime of the LED lamp according to the present invention could be lengthened. Resulting from that configuration, while the LED lamp according to the present invention is used in car as a headlight, the LED bead group arranged on the end surface could serve as a high beam light, the LED bead group arranged on the side surface and close to the end surface could be used as an indicator light, and the other LED bead group arranged on the side surface could be used as a low beam light.

### BRIEF DESCRIPTION OF DRAWINGS:

Further details and advantages of the present invention are explained using embodiments, with reference to the attached drawings. In the drawings:

FIG. 1 is front view of the present invention; and

FIG. 2 is a top view of the present invention.

### DETAILED DESCRIPTION OF THE INVENTION

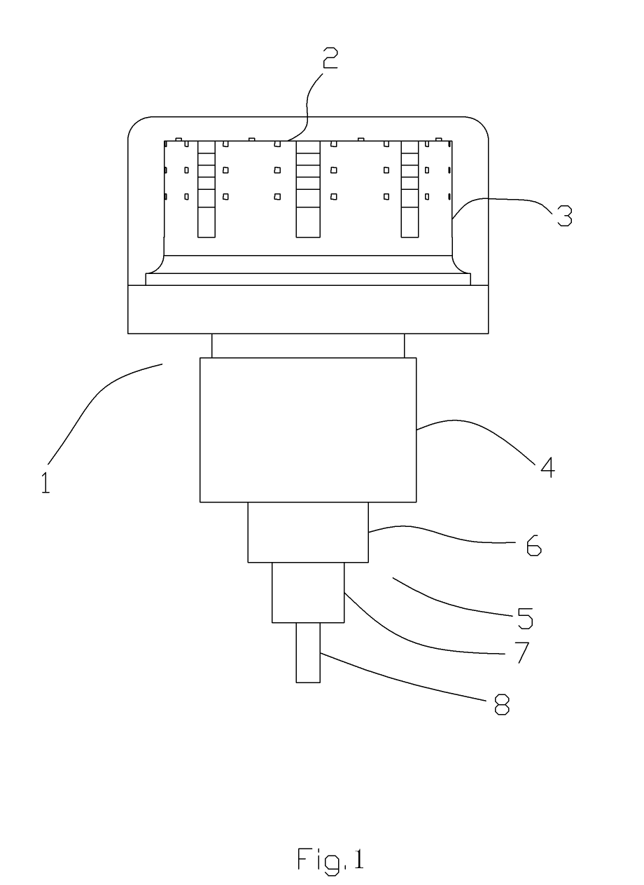

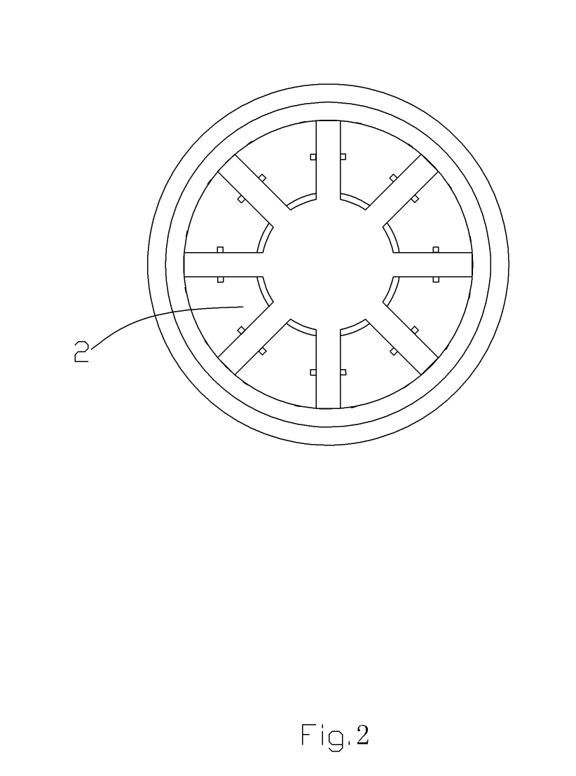

As shown by FIGS. 1 and 2, the present invention discloses a multiunit and multifaceted LED lamp, comprising a lamp body 1 having an end surface 2 and a side surface 3, a plurality of LED bead groups are arranged on the end and side surfaces 2 and 3 respectively, furthermore on the lamp body 1 a connecting apparatus which is able to connect the LED bead groups to an external power source is arranged, and through the different connection modes of the connecting apparatus different LED bead groups are turned on or off under control. In addition, the connecting apparatus comprises a negative connecting terminal 4 connected to the corresponding LED bead groups and a positive connecting terminal 5 connected to the corresponding LED bead groups.

In the embodiment shown in FIG. 1, the end surface 2 and the side surface 3 may be the end and side surfaces of a cylinder respectively, an LED bead group is arranged on the end surface 2, whereon the LED beads are evenly distributed; two LED bead groups are arranged on the side surface 3, wherein the two LED bead groups are disposed on the two sides of the side surface 3 respectively, and whereon the LED beads are evenly distributed as well. The LED lamp further comprises a transparent protective shell arranged on the end surface 2 and side surface 3 for protection, and the LED bead groups in the present invention may comprises the LED beads with various colors for different luminous effects. The positive connecting terminal 5 consists of a first connecting end 6, a second connecting end 7 and a third connecting end 8, which are connected to the corresponding LED bead groups respectively. The positive connecting terminal 4 may be a threaded cylindrical shell, and this threaded configuration could provide convenience for connecting the LED lamp to the external power source. The first connecting terminal 6, second connecting terminal 7 and third connecting terminal 8 may be three lengths of cylindrical shells with different diameters, wherein one end of the first connecting terminal 6 is inserted into the negative connecting terminal 4; one end of the second connecting terminal 7 is inserted into the first connecting terminal 6; and one end of the third connecting terminal 8 is inserted into the second connecting terminal 7. The negative connecting terminal 4, the first connecting terminal 6, the second connecting terminal 7 and the third connecting terminal 8 are separated with each other by insulators, this configuration provides convenience for connecting the first, second and third connecting terminals 6, 7 and 8 to the power source.

While the LED lamp according to the present invention is installed in a car as a headlight, the negative connecting terminal 4 should be connected to the positive pole of the power source. When the first connecting terminal 6 is connected to the negative pole of the power source, the LED bead group arranged on the end surface 2 lights up, at that time the LED lamp serves as a high beam light; when the second connecting terminal 7 is connected to the negative pole of the power source, the LED bead group arranged on the side surface 3 and close to the end surface 2 lights up, at that time the LED lamp serves as an indicator light; when the third connecting terminal 8 is connected to the negative pole of the power source, the other LED bead group on the side surface 3 lights up, and the LED lamp at that time serves as a low beam light; and when the first, second and third connecting terminals 6, 7 and 8 are connected to the positive pole of the power source simultaneously, all LED bead groups light up. In particular, yellow phosphor is applied on the end surface 2 and side surface 3, thus through the yellow phosphor applied, the LED lamp is able to emit yellow light, which is not only able to increase brightness but also has more penetrability.

While the invention has been described in terms of what are presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structure

1. A multiunit and multifaceted lighting LED lamp, characterized in that: the LED lamp comprises:
a lamp body (1), provided with an end surface (2) and a side surface (3);
LED bead groups, arranged on the end surface (2) and side surface (3);
a connecting apparatus, arranged on the lamp body (1), and connecting the LED bead groups to a power source;
wherein the LED bead groups can be switched on or off respectively under the control of the connecting apparatus through the different connection modes of the connecting apparatus.

2. The multiunit and multifaceted LED lamp according to claim 1, wherein the connecting apparatus comprises a negative connecting terminal (4) connected to the LED bead groups, and a positive connecting terminal (5) connected to the corresponding LED bead groups.

3. The multiunit and multifaceted LED lamp according to claim 2, wherein one LED bead group is arranged on the end surface (2) and two LED bead groups are arranged on the side surface (3).

4. The multiunit and multifaceted LED lamp according to claim 3, wherein the positive connecting terminal (5) comprises a first connecting terminal (6), a second connecting terminal (7) and a third connecting terminal (8), which are connected to the corresponding LED bead groups respectively.

5. The multiunit and multifaceted LED lamp according to claim 4, wherein the negative connecting terminal (4) may be a threaded cylindrical shell, and the first connecting terminal (6), second connecting terminal (7) and third connecting terminal (8) may be three lengths of cylindrical shells with different semi-diameters, wherein one end of the first connecting terminal (6) is inserted into the negative connecting terminal (4); one end of the second connecting terminal (7) is inserted into the first connecting terminal (6); one end of the third connecting terminal (8) is inserted into the second connecting terminal (7); and the negative connecting terminal (4), the first connecting terminal (6), the second connecting terminal (7) and the third connecting terminal (8) are separated with each other by insulators.

6. The multiunit and multifaceted LED lamp according to claim 1, wherein the LED lamp further comprises phosphor applied on the end surface (2) and side surface (3).
